(19) United States
(12) Patent Application Publication
(10) Pub. No.: US 2022/0366465 A1
(43) Pub. Date: Nov. 17, 2022

(54) My Price Application

(71) Applicant: Grigor J. Bazayan, Los Angeles, CA (US)

(72) Inventor: Grigor J. Bazayan, Los Angeles, CA (US)

(21) Appl. No.: 17/579,854

(22) Filed: Jan. 20, 2022

Related U.S. Application Data
(60) Provisional application No. 63/187,819, filed on May 12, 2021.

(51) Int. Cl. G06Q 30/02; G06Q 30/06

(52) U.S. Cl. CPC G06Q 30/0283; G06Q 30/0609; G06Q 30/0611

(57) ABSTRACT

The present invention provides a price system that comprises a sign-up process, a business process and a customer process. The system provides a method of displaying a first display, receiving the at least one credential from a user, receiving the at least one business content that includes one or more goods and services of a business, displaying a second display based on the at least one credential, displaying the at least one offer, where in the second display will display a payment method if the offer is accepted by a business.

### FIELD OF THE INVENTION

The present invention relates to software application. More specifically, the present invention is a commerce software application.

### BACKGROUND OF THE INVENTION

When it comes to making finding the right price for specific goods/services, there are many different existing methods, processes, and systems to do so. The primary issue of existing commerce and trading methods, processes and systems is that the standard procedure is that the business presents a price for a good/service to the customers to let the customers decide if they think it is worth purchasing/paying for. The aforementioned procedure limit the customer as the customer is not able to offer a price more suitable for themselves.

An objective of the present invention is to provide a software application utilized for the commerce of goods/services. The present invention provides a system that allow customers to offer a suitable price for a good/service from a business.

### SUMMARY

In accordance with the present invention, a price system and a method are provided. The present invention provides a price system that comprises a sign-up process, a business process and a customer process. The system provides a method of displaying a first display, receiving the at least one credential from a user, receiving the at least one business content that includes one or more goods and services of a business, displaying a second display based on the at least one credential, displaying the at least one offer, where in the second display will display a payment method if the offer is accepted by a business.

The price system allows a user input their credentials and business owners can input their business information as their credentials so that based on the credentials, the price system can display the business goods and services and accept or decline the offers provided by the customers using the price system.

By using the present invention, business owners can publish and advertise their goods and services and a customer who uses the present invention may propose and offer a suitable price value for a good/service provided by a business.

### BRIEF DESCRIPTION OF THE DRAWINGS

FIG. 1 is an illustration of one embodiment of the present invention.

FIG. 2 is a flow chart illustrating a sign-up process of the present invention.

FIG. 3 is a flow chart illustrating a business process of the present invention.

FIG. 4 is a flow chart illustrating a customer process of the present invention.

FIG. 5 is a flow chart illustrating a price method of the present invention.

FIG. 6 is an illustration showing a first display and a second display of the present invention.

### DETAIL DESCRIPTIONS OF THE INVENTION

All illustrations of the drawings are for the purpose of describing selected versions of the present invention and are not intended to limit the scope of the present invention.

The present invention provides a software application utilized for the commerce of goods/services. The present invention provides a system to allow customers to propose and offer a suitable price value for a good/service. The present invention primarily comprises three user-interface processes.

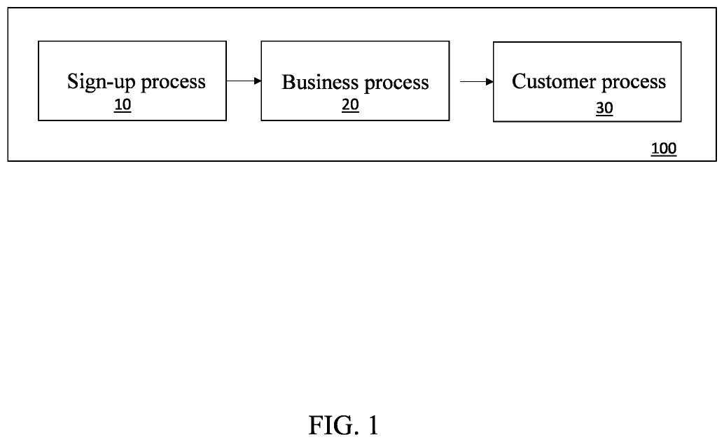

As shown in FIG. 1, the present invention provides a price system 100 that comprises a plurality of processors and a plurality of memories, the latter of which contain instructions that when executed by a processor trigger a sign-up process 10, a business process 20 and a customer process 30. The instructions may include routines, programs, objects, data structures, and the like.

The price system 100 can be implemented in a network environment, which may comprise one or more servers or one or more data stores. In some embodiments, the price system 100 of the present invention can be loaded on a user's computing device, which may be communicatively connected to a network.

In other embodiments, the price system 100 may be deployed on a computing device such that the price system 100 is configured as a cloud system.

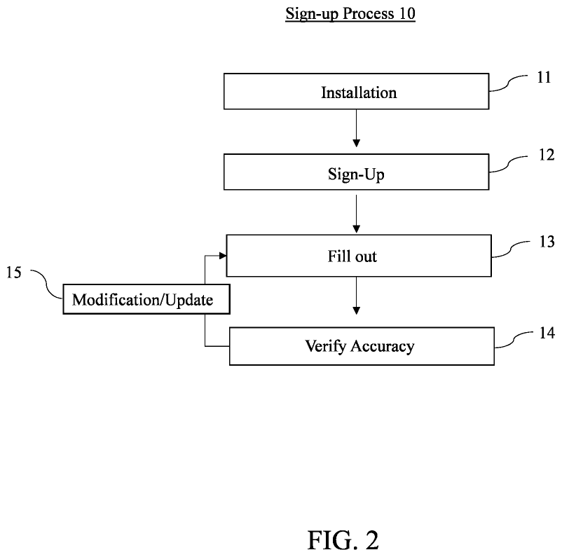

The sign-up process 10 is the initial procedure for all users of the present invention. The user of the present invention can be a customer or a business. The user will begin by installing the software application to a user's computing device such as a smart device/mobile device. As shown in FIG. 2, after the download and installation (installation step 11) of the present invention, the user will proceed with signing up a personal account (sign up step 12). The user will be required to fill out required credentials (fill out step 13) during this process. The credentials will assist with verifying and determining if the user is using the present invention as a business or as a customer, or perhaps both. After entering the necessary credentials, the user will verify (verify Accuracy step 14) that all information provided is accurate.

For the credentials, the sign-up process 10 may provide a questionnaire, including by means of a web form, through which users can supply the various data necessary for the credentials. In one embodiment, the credentials may include name, business name, sign-up date and time, product and/or services offered, pictures or video commercials, and the like.

In some embodiments, the sign-up process 10 may include a modification/update process 15 that allows the user to modify and update the user's credentials.

In some embodiments, the sign-up process 10 may also include a payment process through which to accept payment.

The business process 20 is the general procedure after the sign-up process 10 for business users of the present invention. After the sign-up process 10, the credentials will determine that the user is a business user of the present invention.

The business user will publish and advertise their business to goods/services. Once goods/services are advertised and presented to the customers, the business user of the present invention will be on standby for incoming offers.

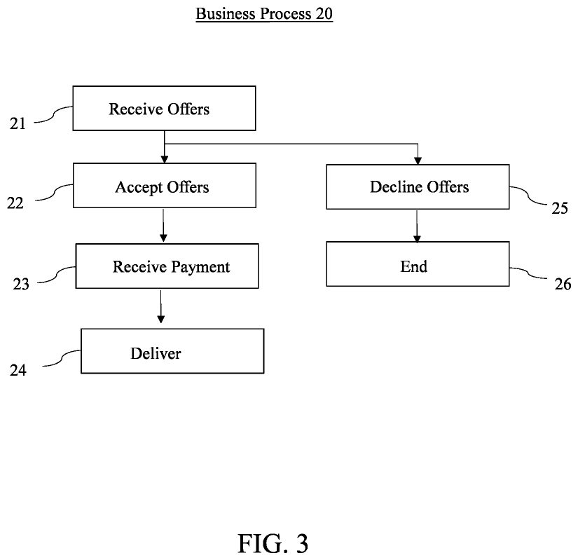

As shown in FIG. 3, the business user will receive offers 21 about specific goods/services that are available by their business. The business user will either accept (accept offers 22) or decline (decline offers 25) incoming price offerings by customers. If the business user decides to accept an offer, they wait for payments to be received (receive payment 23) then proceed to deliver the good/service to the customer (deliver 24).

If the business user decides to decline an offer (decline offers 25), no further action is needed and the process will end (end 26). Furthermore, in one embodiment, the business user is able to browse a posting section (where the goods/services are advertised) to accept posted offers for specified services of potential customers.

The customer process 30 is the general procedure after the sign-up process 10 for customers using the present invention. After the sign-up process 10, the credentials will determine that the user is a customer browsing the present invention.

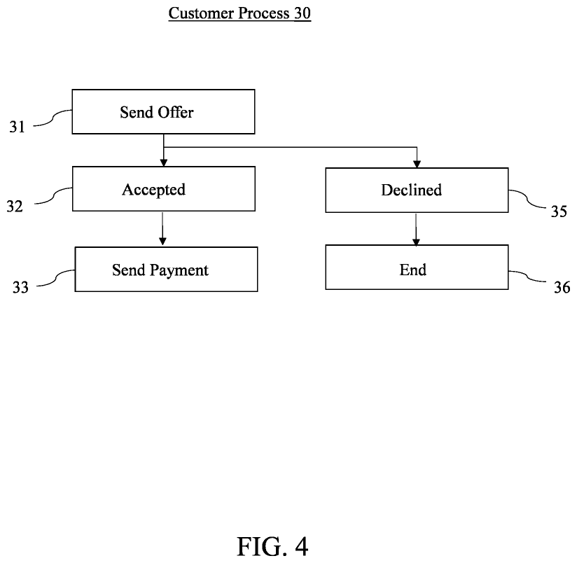

The customer will browse under the category or related sections of the goods/service needed. Under the aforementioned section, as shown in FIG. 4, the customer will post and present a desired offer (send offer 31) of their choice for the specified goods/service for any business to see.

In addition to the post and presentation of the user's desired offer for the good/service, the user will be able to post details and information about the good/service that is needed. At this point in time, the customer will wait until a business have accepted 32 or declined 35 the offer/proposal price. If the offer has been accepted by the business, the customer will send the corresponding payment (send payment 33) to the business for the good/service. If the offer has been declined by the business, the customer does not need to pay as well as no further action is needed by the customer.

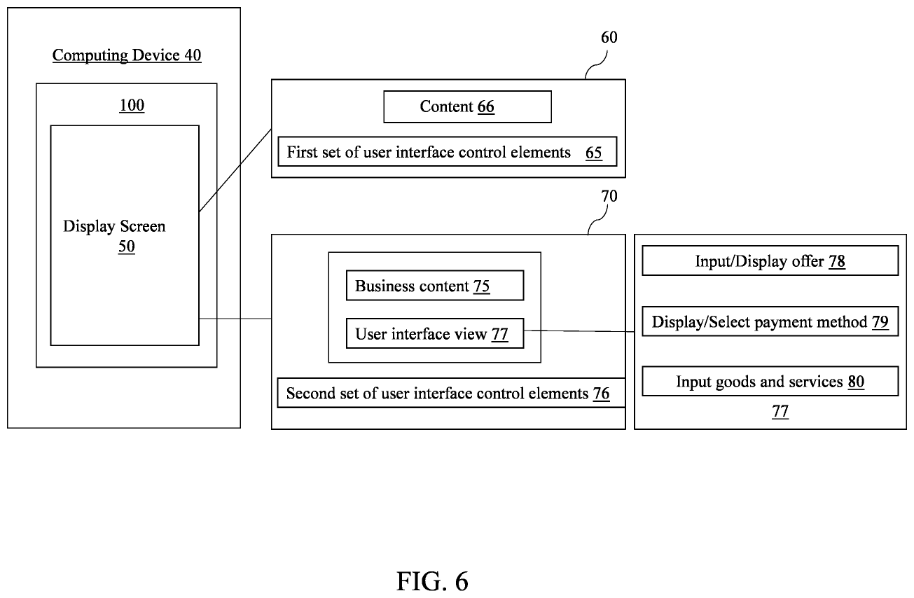

The price system 100 of the present invention can be operating on a computing device 40 that may include a display screen 50 as shown in FIG. 6.

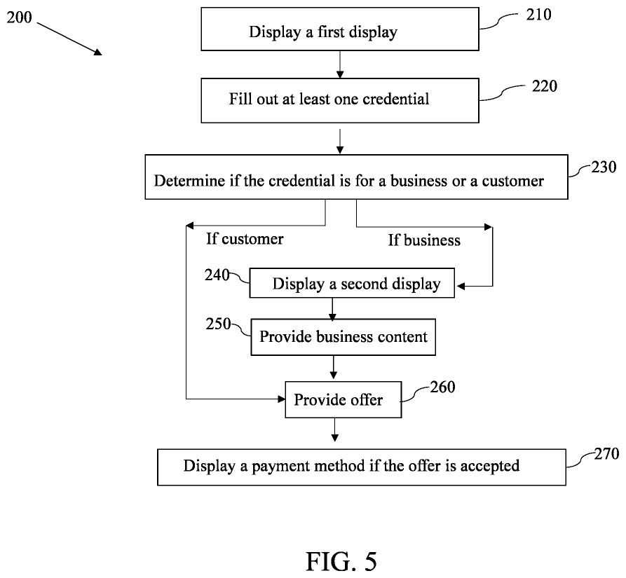

By the three user-interface processes—a sign-up process 10, a business process 20 and a customer process 30—the price system 100 of the present invention can provide a price method 200 (as shown in FIG. 5) comprising steps to:

display a first display 210;

fill out at least one credential 220;

determine if the credential is for a business or a customer 230;

display a second display 240;

provide business content 250;

provide offer 260; and

display a payment method if the offer is accepted 270.

In some embodiments, as shown in FIG. 6, the price system 100 of the present invention may display a first display 60 having a first set of user interface control elements 65 and a content 66 where the content 66 may include a web form configured to request a user to fill out at least one credential.

The first set of user interface control elements 65 may provide a modification process that allows a user to modify and update the at least one credential provided by the user. After receiving at least one credential, the price system 100 may determine if the credential is for a business or a customer. If the price system 100 determines that the credential is for a business, the price system 100 of the present invention may allow the user (business) to provide at least one business content 75 that includes one or more goods and services so that the system can publish and advertise to customers. This business content 75 can be displayed on a second display 70 having a second set of user interface control elements 76 and the at least one business content 75.

The second set of user interface control elements 76 can be in a form of web buttons and can be enabled to control operations of the price system 100.

In some embodiments, the second set of user interface control elements 76 can be different from the first set of user interface control elements 65.

The price system 100 may provide a user interface view 77 that is configured to receive (input) at least one offer from the customer and display the offer (Input/Display offer 78), before it is accepted or declined by the business, within the second display 70, where in the second display 70 will display a payment method (Display/Select payment method 79) if the offer is accepted by the business who advertised the goods and services.

In some embodiments, the second set of user interface control elements 76 can include one or more web buttons so that the business can accept or decline the offer.

In some embodiments, the second display 70 may include a user interface view 77 configured to input one or more goods and services (input goods and services 80). In yet some other embodiments, the second display 70 may include a user interface view 77 configured to select one or more payment method (Display/Select payment method 79).

In some embodiments, the presentation invention 100 may present a first display 60, while the second display 70 is blank or turned off.

As an optional embodiment, the price system 100 can be configured for the customers to post price information (which may include services/products needed) in a way that the business can view the postings provided by the customers. In such embodiments, one or more businesses can show their interests to the postings and the customers can browse the businesses that showed their interests. If the customers decide to purchase services/products of the business that showed interests, the customers can select one of the businesses that showed interests and make payments in such embodiments.

The processes described in connection with the embodiments disclosed herein can be embodied directly in hardware, in a software module executed by a processor, or in a combination of the two. A software module can reside in a memory unit that can include volatile memory, non-volatile memory, and network devices, or other data storage devices now known or later developed for storing information/data. The volatile memory may be any type of volatile memory including, but not limited to, static or dynamic, random access memory (SRAM or DRAM). The non-volatile memory may be any non-volatile memory including, but not limited to, ROM, EPROM, EEPROM, flash memory, and magnetically or optically readable memory or memory devices such as compact discs (CDs) or digital video discs (DVDs), magnetic tape, and hard drives.

The computing device may be a laptop computer, a cellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type. In example embodiments, network can be configured to provide and employ 5G wireless networking features and functionalities.

Although the invention has been explained in relation to its preferred embodiment, it is to be understood that many other possible modifications and variations can be made without departing from the spirit and scope of the invention.

What is claimed is:

1. A method comprising:
displaying a first display, the first display having a first set of user interface control elements and a content, the content having a web form requesting to fill out at least one credential and the user interface control elements includes a modification process that allows a user to modify and update the at least one credential;
receiving the at least one credential; based on the at least one credential, receiving the at least one business content that includes one or more goods and services;
displaying a second display based on the at least one credential, the second display having a second set of user interface control elements and the at least one business content, wherein the second set of user interface control elements are different from the first set of user interface control elements, and wherein the user interface control elements are enabled to control operations of the price system;
receiving at least one offer; and
displaying the at least one offer, before it is accepted or declined, within the second display, where in the second display will display a payment method if the offer is accepted.

2. The method as in claim 1, wherein the second display includes a user interface view configured to input one or more goods and services.

3. The method as in claim 1, wherein the second display includes a user interface view configured to input one or more offers.

4. The method as in claim 1, wherein the second display includes a user interface view configured to select one or more payment methods.
